(19) United States
(12) Patent Application Publication
(10) Pub. No.: US 2026/0302037 A1
(43) Pub. Date: Oct. 1, 2026

(54) COIL COMPONENT

(71) Applicant: TDK Corporation, Tokyo (JP)

(72) Inventors: Hokuto EDA, Tokyo (JP); Kohei TAKAHASHI, Tokyo (JP); Takahiro NEMOTO, Tokyo (JP); Yuma USAMI, Tokyo (JP); Ryota ISHIKAWA, Tokyo (JP)

(73) Assignee: TDK Corporation, Tokyo (JP)

(21) Appl. No.: 19/632,671

(22) Filed: Mar. 30, 2026

(30) Foreign Application Priority Data
Mar. 31, 2025 (JP) 2025-057692

(51) Int. Cl. H01F 27/06; H01F 27/32

(52) U.S. Cl. CPC H01F 27/06; H01F 27/323; H01F 27/065

(57) ABSTRACT

In a coil component, because a length of an outer side surface of a winding of each planar coil portion is shorter than a length of an inner side surface, compared to a case where, for example, the outer side surface and the inner side surface have the same length, an opposing area of both windings is reduced, and stray capacitance generated between the both windings is reduced.

### CROSS-REFERENCE TO RELATED APPLICATIONS

This application is based upon and claims the benefit of priority from Japanese Patent Application No. 2025-57692, filed on Mar. 31, 2025, the entire contents of which are incorporated herein by reference.

### TECHNICAL FIELD

The present disclosure relates to a coil component.

### BACKGROUND

U.S. Patent Application Publication No. 2024/0224023 discloses a coil component including a coil that has a first coil portion spirally wound on one surface of an insulating substrate provided in an element body, a second coil portion spirally wound on the other surface, and a through-hole conductor penetrating the insulating substrate to electrically connect the first coil portion and the second coil portion, and a pair of external terminals provided on a surface of the element body and respectively connected to both ends of the coil.

### SUMMARY

In the coil component as described above, stray capacitance may occur between various conductors constituting the coil component. The inventors, as a result of diligent research, have newly found a technique that can reduce stray capacitance.

According to the present disclosure, a coil component capable of reducing stray capacitance is provided.

A coil component according to one aspect of the present disclosure includes an element body having a pair of principal surfaces facing each other and a first end face and a second end face connecting the pair of principal surfaces, an insulating substrate provided in the element body, extending parallel to the principal surface of the element body, and having a first main surface and a second main surface respectively facing the pair of principal surfaces of the element body, a coil assembly provided in the element body and having a first coil that includes a spiral first coil portion provided on the first main surface of the insulating substrate, a spiral second coil portion provided on the second main surface of the insulating substrate, and a first through-hole conductor penetrating the insulating substrate to electrically connect the first coil portion and the second coil portion, and a first external terminal provided on the first end face and electrically connected to an outer end portion of the first coil portion, wherein with respect to a length in a thickness direction of the insulating substrate, a length of an outer side surface of an outermost winding of the second coil portion is shorter than a length of an inner side surface of the outermost winding of the second coil portion.

A coil component according to one aspect of the present disclosure includes an element body having a pair of principal surfaces facing each other and a first end face and a second end face connecting the pair of principal surfaces, an insulating substrate provided in the element body, extending parallel to the principal surface of the element body, and having a first main surface and a second main surface respectively facing the pair of principal surfaces of the element body, a coil assembly provided in the element body and having a first coil that includes a spiral first coil portion provided on the first main surface of the insulating substrate, a spiral second coil portion provided on the second main surface of the insulating substrate, and a first through-hole conductor penetrating the insulating substrate to electrically connect the first coil portion and the second coil portion, a first external terminal provided on the first end face and electrically connected to an outer end portion of the first coil, and a pair conductor provided on the second main surface of the insulating substrate adjacent to the first end face and electrically connected to the first external terminal, wherein with respect to a length in a thickness direction of the insulating substrate, a length of an outer side surface in an outermost winding of the second coil portion is shorter than a length of an inner side surface in the outermost winding of the second coil portion.

A coil component according to one aspect of the present disclosure includes an element body having a pair of principal surfaces facing each other and a first end face and a second end face connecting the pair of principal surfaces, an insulating substrate provided in the element body, extending parallel to the principal surface of the element body, and having a first main surface and a second main surface respectively facing the pair of principal surfaces of the element body, and a coil assembly provided in the element body and having a first coil that includes a spiral first coil portion provided on the first main surface of the insulating substrate, a spiral second coil portion provided on the second main surface of the insulating substrate, and a first through-hole conductor penetrating the insulating substrate to electrically connect the first coil portion and the second coil portion, wherein at least one of the first coil portion and the second coil portion includes a first winding and a second winding adjacent to an outer peripheral side of the first winding, and with respect to a length in a thickness direction of the insulating substrate, a length of an outer side surface in the first winding is shorter than a length of an inner side surface in the first winding.

### BRIEF DESCRIPTION OF THE DRAWINGS

FIG. 1 is a schematic perspective view of a coil component according to an embodiment.

FIG. 2 is a diagram showing an interior of the coil component of FIG. 1.

FIG. 3 is an exploded view of the coil shown in FIG. 2.

FIG. 4 is a plan view of the interior of the coil component shown in FIG. 2.

FIG. 5 is a cross-sectional view taken along line V-V of the coil component shown in FIG. 2.

FIG. 6 is a cross-sectional view taken along line VI-VI of FIG. 4.

FIG. 7 is a cross-sectional view taken along line VII-VII of FIG. 4.

FIG. 8 is a cross-sectional view taken along line VIII-VIII of FIG. 4.

FIG. 9 is a cross-sectional view taken along line IX-IX of FIG. 4.

### DETAILED DESCRIPTION

Hereinafter, embodiments of the present disclosure will be described in detail with reference to the accompanying drawings. In the description, the same reference numerals will be used for the same elements or elements having the same functions, and redundant description will be omitted.

A coil component 1 according to an embodiment is a balun coil. The balun coil is used, for example, when a near field communication circuit (NFC circuit) is mounted on a cellular terminal. The balun coil performs conversion between an unbalanced signal of an antenna and a balanced signal of the NFC circuit, thereby realizing connection between an unbalanced circuit and a balanced circuit.

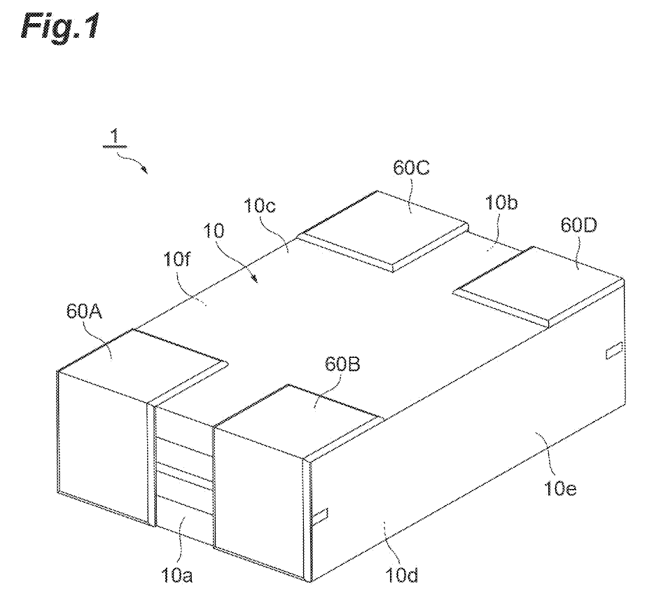

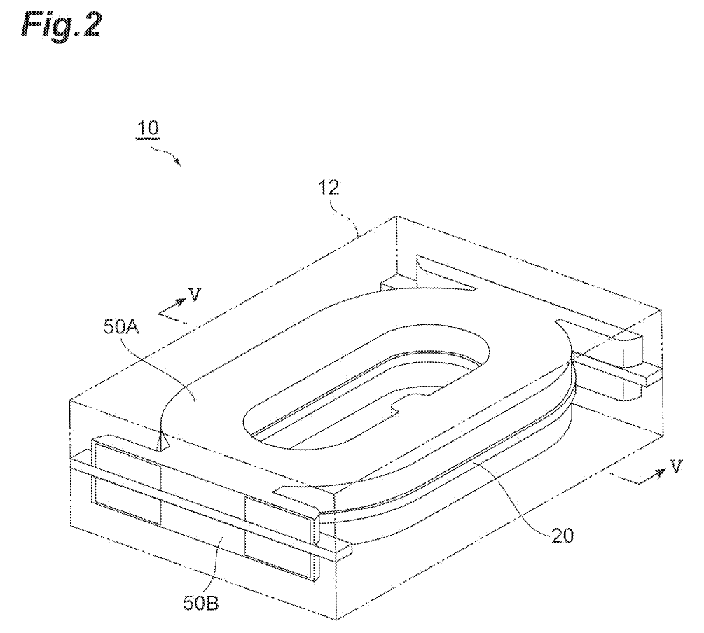

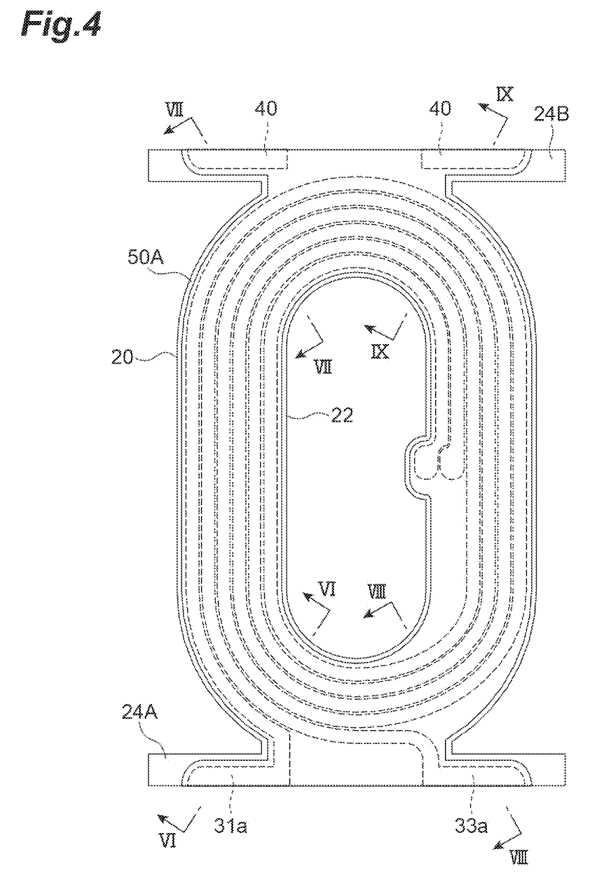

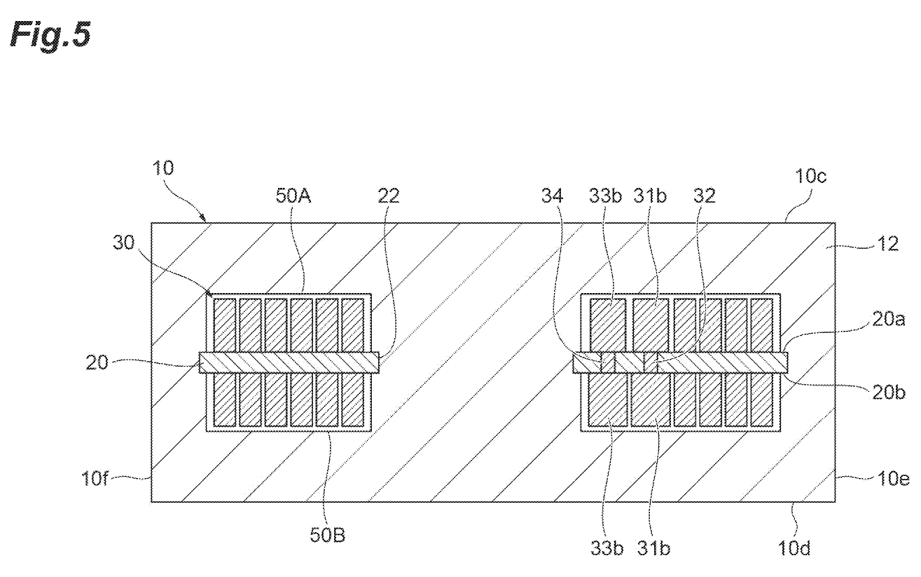

As shown in FIGS. 1 to 5, the coil component 1 is configured to include an element body 10, an insulating substrate 20 embedded in the element body 10, a coil assembly 30 provided on the insulating substrate 20 within the element body 10, and two pairs of external terminal electrodes 60A, 60B, 60C, and 60D provided on a surface of the element body 10.

The element body 10 has a rectangular parallelepiped outer shape and has six faces 10a to 10f. The element body 10 is designed, for example, with dimensions of a long side of 2.0 mm, a short side of 1.25 mm, and a height of 0.65 mm. Among the faces 10a to 10f of the element body 10, an end face 10a (first end face) and an end face 10b (second end face) are parallel to each other, an upper surface 10c (principal surface) and a lower surface 10d (principal surface) are parallel to each other, and a side face 10e and a side face 10f are parallel to each other. The upper surface 10c of the element body 10 is a surface that faces parallel to a mounting surface of a mounting substrate on which the coil component 1 is mounted.

The element body 10 is made of a metal magnetic powder-containing resin 12, which is a type of magnetic material. The metal magnetic powder-containing resin 12 is a bound powder in which metal magnetic powder is bound by a binder resin. The metal magnetic powder of the metal magnetic powder-containing resin 12 is composed of, for example, an iron-nickel alloy (Permalloy alloy), carbonyl iron, amorphous, an amorphous or crystalline FeSiCr-based alloy, Sendust, or the like. The binder resin is, for example, a thermosetting epoxy resin. In the present embodiment, the content of the metal magnetic powder in the bound powder is 80 to 92 vol% in volume percent, and 95 to 99 wt% in mass percent. From the viewpoint of magnetic properties, the content of the metal magnetic powder in the bound powder may be 85 to 92 vol% in volume percent and 97 to 99 wt% in mass percent. The magnetic powder of the metal magnetic powder-containing resin 12 may be a powder having one type of average particle size, or may be a mixed powder having a plurality of types of average particle sizes.

The metal magnetic powder-containing resin 12 of the element body 10 integrally covers an insulating substrate 20 and a coil assembly 30, which will be described later. Specifically, the metal magnetic powder-containing resin 12 covers the coil assembly 30 from above and below, and also covers an outer periphery of the coil assembly 30. Furthermore, the metal magnetic powder-containing resin 12 fills an inner peripheral region of the coil assembly 30.

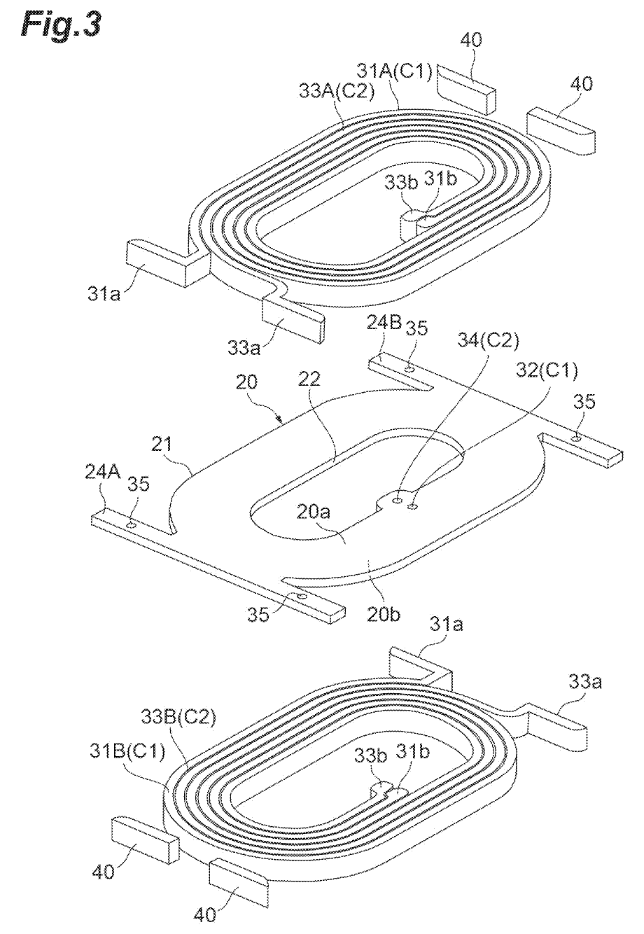

The insulating substrate 20 has a flat plate shape, extends between the end faces 10a and 10b of the element body 10, and is designed to be orthogonal to the end faces 10a and 10b. The insulating substrate 20 also extends parallel to the upper surface 10c and the lower surface 10d of the element body 10. As shown in FIG. 3, the insulating substrate 20 has an elliptical annular coil forming portion 21 extending along a long-side direction of the element body 10, and a pair of frame portions 24A and 24B extending along a short-side direction of the element body 10 and sandwiching the coil forming portion 21 from both sides. An elliptical opening 22 extending along the long-side direction of the element body 10 is provided in a central portion of the coil forming portion 21.

The insulating substrate 20 is made of a non-magnetic insulating material. The thickness of the insulating substrate 20 can be designed, for example, in a range of 10 to 60 μm. In the present embodiment, the insulating substrate 20 has a configuration in which glass cloth is impregnated with an epoxy-based resin. The resin constituting the insulating substrate 20 is not limited to an epoxy-based resin, and may be a BT resin, polyimide, aramid, or the like. The constituent material of the insulating substrate 20 may be ceramic or glass. The constituent material of the insulating substrate 20 may be a mass-produced printed circuit board material. The constituent material of the insulating substrate 20 may be a resin material used for a BT printed circuit board, an FR4 printed circuit board, or an FR5 printed circuit board.

The coil assembly 30 includes a first coil C1 and a second coil C2 that constitute a double coil structure. The first coil C1 is configured to include a first planar coil portion 31A (first coil portion) spirally wound on an upper surface 20a (first main surface) of the insulating substrate 20, a second planar coil portion 31B (second coil portion) spirally wound on a lower surface 20b (second main surface) of the insulating substrate 20, and a first through conductor 32 (first through-hole conductor) connecting the first planar coil portion 31A and the second planar coil portion 31B. The second coil C2 is configured to include a third planar coil portion 33A (third coil portion) spirally wound on the upper surface 20a of the insulating substrate, a fourth planar coil portion 33B (fourth coil portion) spirally wound on the lower surface 20b of the insulating substrate 20, and a second through conductor 34 (third through-hole conductor) connecting the third planar coil portion 33A and the fourth planar coil portion 33B.

On the upper surface 20a of the insulating substrate 20, the first planar coil portion 31A of the first coil C1 and the third planar coil portion 33A of the second coil C2 are wound in an adjacent state so as to be parallel. On the lower surface 20b of the insulating substrate 20, the second planar coil portion 31B of the first coil C1 and the fourth planar coil portion 33B of the second coil C2 are wound in an adjacent state so as to be parallel.

The first planar coil portion 31A is a substantially oblong air-core coil spirally wound around the opening 22 of the coil forming portion 21 within the same layer on the upper surface 20a of the insulating substrate 20. The number of turns of the first planar coil portion 31A may be one turn or a plurality of turns. In the present embodiment, the number of turns of the first planar coil portion 31A is 3 to 4. The first planar coil portion 31A has an outer end portion 31a and an inner end portion 31b. The outer end portion 31a is provided on the frame portion 24A and is exposed from the end face 10a of the element body 10. The inner end portion 31b is provided at an edge of the opening 22. The insulating substrate 20 is provided with a first through conductor 32 extending in a thickness direction of the insulating substrate 20 at a position overlapping the inner end portion 31b of the first planar coil portion 31A. The first planar coil portion 31A is made of, for example, Cu and can be formed by electrolytic plating. The first through conductor 32 can be configured with a hole provided in the insulating substrate 20 and a conductive material (for example, a metal material such as Cu) filled in the hole.

The second planar coil portion 31B has symmetry with the first planar coil portion 31A. More specifically, the second planar coil portion 31B has a shape obtained by inverting the first planar coil portion 31A around an axis parallel to a short side of the element body 10. An outer end portion 31a of the second planar coil portion 31B is provided on the frame portion 24B and is exposed from the end face 10b of the element body 10. An inner end portion 31b of the second planar coil portion 31B overlaps with the first through conductor 32 provided in the insulating substrate 20. Therefore, the inner end portion 31b of the second planar coil portion 31B is electrically connected to the inner end portion 31b of the first planar coil portion 31A via the first through conductor 32. In the first coil C1, the outer end portion 31a of the first planar coil portion 31A constitutes a first end portion, and the outer end portion 31a of the second planar coil portion 31B constitutes a second end portion. The third planar coil portion 33A is made of, for example, Cu and can be formed by electrolytic plating.

The third planar coil portion 33A, like the first planar coil portion 31A, is a substantially oblong air-core coil spirally wound around the opening 22 of the coil forming portion 21 within the same layer on the upper surface 20a of the insulating substrate 20. The third planar coil portion 33A is wound on an inner peripheral side of the first planar coil portion 31A so as to be adjacent to the first planar coil portion 31A. The number of turns of the third planar coil portion 33A may be one turn or a plurality of turns. In the present embodiment, the number of turns of the third planar coil portion 33A is the same as the number of turns of the first planar coil portion 31A. The third planar coil portion 33A has an outer end portion 33a and an inner end portion 33b. The outer end portion 33a of the third planar coil portion 33A, like the outer end portion 31a of the first planar coil portion 31A, is provided on the frame portion 24A and is exposed from the end face 10a of the element body 10. The inner end portion 33b of the third planar coil portion 33A is provided at an edge of the opening 22 and is adjacent to the inner end portion 31b of the first planar coil portion 31A. The insulating substrate 20 is provided with a second through conductor 34 extending in a thickness direction of the insulating substrate 20 at a position overlapping the inner end portion 33b of the third planar coil portion 33A. The third planar coil portion 33A, like the first planar coil portion 31A, is made of, for example, Cu and can be formed by electrolytic plating. The second through conductor 34 can be configured with a hole provided in the insulating substrate 20 and a conductive material (for example, a metal material such as Cu) filled in the hole.

The fourth planar coil portion 33B has symmetry with the third planar coil portion 33A. More specifically, the fourth planar coil portion 33B has a shape obtained by inverting the third planar coil portion 33A around an axis parallel to a short side of the element body 10. An outer end portion 33a of the fourth planar coil portion 33B is provided on the frame portion 24B and is exposed from the end face 10b of the element body 10. An inner end portion 33b of the fourth planar coil portion 33B overlaps with the second through conductor 34 provided in the insulating substrate 20. Therefore, the inner end portion 33b of the fourth planar coil portion 33B is electrically connected to the inner end portion 33b of the third planar coil portion 33A via the second through conductor 34. In the second coil C2, the outer end portion 33a of the third planar coil portion 33A constitutes a first end portion, and the outer end portion 33a of the fourth planar coil portion 33B constitutes a second end portion. The fourth planar coil portion 33B is made of, for example, Cu and can be formed by electrolytic plating.

In the present embodiment, four pair conductors 40 are formed on the insulating substrate 20. Each pair conductor 40 overlaps with a respective outer end portion 31a and 33a of the four planar coil portions 31A, 31B, 33A, and 33B via the insulating substrate 20. The pair conductor 40 and the outer end portions 31a and 33a are connected to each other by a through conductor 35 (second through-hole conductor) provided in the insulating substrate 20. The pair conductor 40 is made of, for example, Cu, and may be formed by electrolytic plating when the planar coil portions 31A, 31B, 33A, and 33B are formed by electrolytic plating. Each pair conductor 40 has the same shape as each of the outer end portions 31a and 33a when viewed from a thickness direction of the insulating substrate 20. The respective outer end portions 31a and 33a of the four planar coil portions 31A, 31B, 33A, and 33B are each duplicated by the four pair conductors 40, and electrical connectivity with the external terminal electrodes 60A to 60D is enhanced. The through conductor 35 may be provided at a position away from the end faces 10a and 10b and not exposed from the end faces 10a and 10b, or may be exposed from the end faces 10a and 10b. When the through conductor 35 is not exposed from the end faces 10a and 10b, the through conductor 35 and the external terminal electrodes 60A to 60D do not directly contact each other, and a part of the insulating substrate 20 is interposed between the through conductor 35 and the external terminal electrodes 60A to 60D. Since an adhesion force between the external terminal electrodes 60A to 60D and the insulating substrate 20 is stronger than an adhesion force between the external terminal electrodes 60A to 60D and the through conductor 35, by arranging the through conductor 35 so as not to be exposed from the end faces 10a and 10b, the adhesion force of the external terminal electrodes 60A to 60D to the element body 10 is enhanced. It should be noted that it is not always necessary to duplicate the outer end portions 31a and 33a of all four planar coil portions 31A, 31B, 33A, and 33B, and an aspect in which only the outer end portions 31 and 33a of some of the planar coil portions 31A, 31B, 33A, and 33B are duplicated is also possible. The shape of each pair conductor 40 may be a shape that completely overlaps with each of the outer end portions 31a and 33a when viewed from the thickness direction of the insulating substrate 20, or may be a shape that partially overlaps.

The first planar coil portion 31A and the third planar coil portion 33A provided on the upper surface 20a of the insulating substrate 20 are integrally covered by a first insulator 50A. The first insulator 50A includes a plurality of resin walls that cover inner side surfaces and outer side surfaces of each winding of the first planar coil portion 31A and the third planar coil portion 33A, and fill a space between adjacent windings of the first planar coil portion 31A and windings of the third planar coil portion 33A. The resin walls of the first insulator 50A are made of a thick-film resist patterned by known photolithography, and define plating growth regions of the first planar coil portion 31A and the third planar coil portion 33A. In the present embodiment, the first insulator 50A also covers a surface of the pair conductor 40 provided on the upper surface 20a of the insulating substrate 20. The second planar coil portion 31B and the fourth planar coil portion 33B provided on the lower surface 20b of the insulating substrate 20 are integrally covered by a second insulator 50B. The second insulator 50B includes a plurality of resin walls that cover inner side surfaces and outer side surfaces of each winding of the third planar coil portion 33A and the fourth planar coil portion 33B, and fill a space between adjacent windings of the second planar coil portion 31B and windings of the fourth planar coil portion 33B. The resin walls of the second insulator 50B, similar to the resin walls of the first insulator 50A, are made of a thick-film resist patterned by known photolithography, and define plating growth regions of the second planar coil portion 31B and the fourth planar coil portion 33B. In the present embodiment, the second insulator 50B also covers a surface of the pair conductor 40 provided on the lower surface 20b of the insulating substrate 20. The first insulator 50A and the second insulator 50B can be made of, for example, an epoxy-based resin.

The two pairs of external terminal electrodes 60A to 60D are provided one pair each on the end faces 10a and 10b of the element body 10, and are respectively connected to the outer end portions 31a and 33a and the pair conductors 40 of the corresponding planar coil portions 31A, 31B, 33A, and 33B. That is, the external terminal electrode 60A provided on the end face 10a is connected to the outer end portion 31a of the first planar coil portion 31A, the external terminal electrode 60B provided alongside the external terminal electrode 60A on the end face 10a is connected to the outer end portion 33a of the third planar coil portion 33A, the external terminal electrode 60C provided on the end face 10b is connected to the outer end portion 31a of the second planar coil portion 31B, and the external terminal electrode 60D provided alongside the external terminal electrode 60C on the end face 10b is connected to the outer end portion 33a of the fourth planar coil portion 33B. The external terminal electrode 60A on the end face 10a and the external terminal electrode 60C on the end face 10b are provided at positions corresponding to each other in the long-side direction of the element body 10. Similarly, the external terminal electrode 60B on the end face 10a and the external terminal electrode 60D on the end face 10b are provided at positions corresponding to each other in the long-side direction of the element body 10. All of the external terminal electrodes 60A, 60B, 60C, and 60D are bent in an L-shape and continuously cover the end faces 10a and 10b and the upper surface 10c. In the present embodiment, the external terminal electrodes 60A, 60B, 60C, and 60D are made of resin electrodes, and are made of, for example, a resin containing Ag powder.

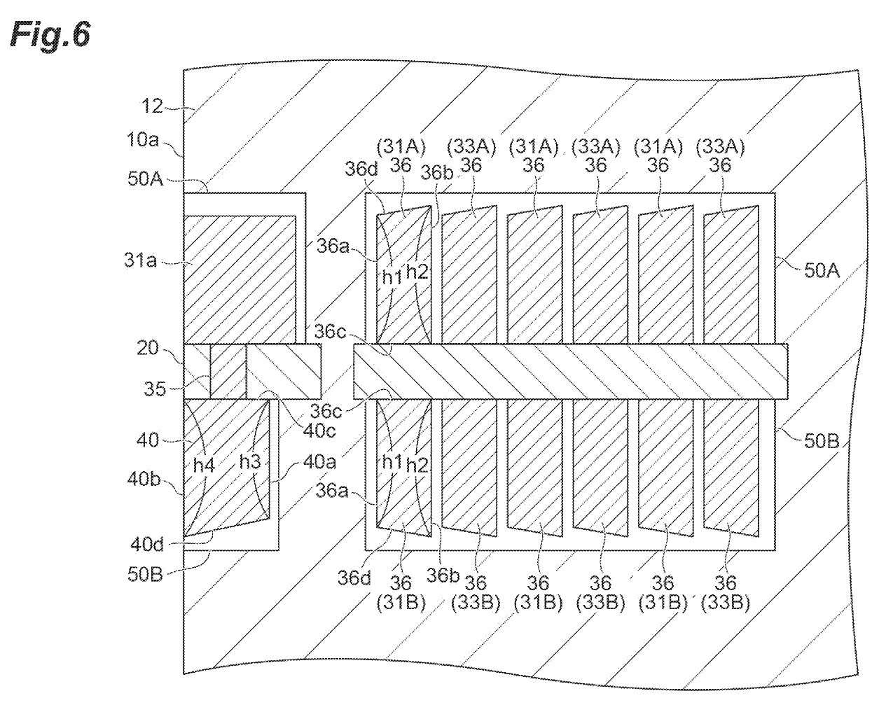

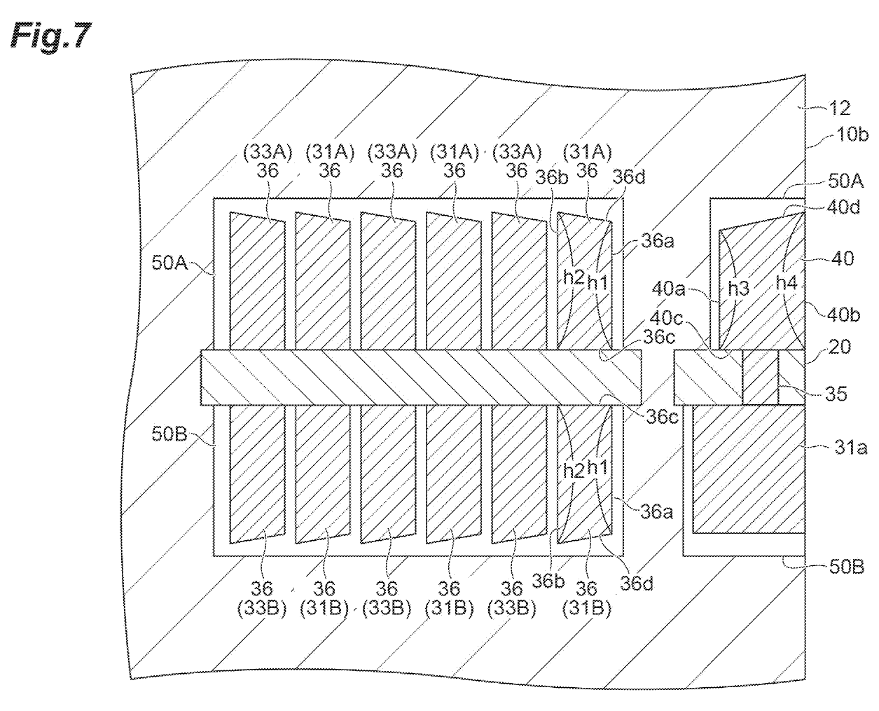

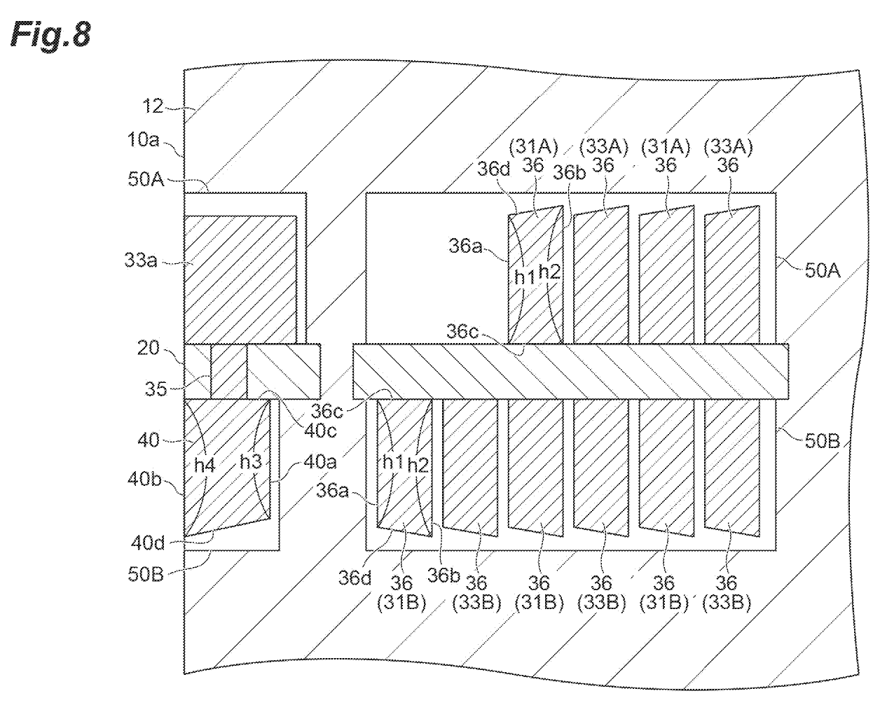

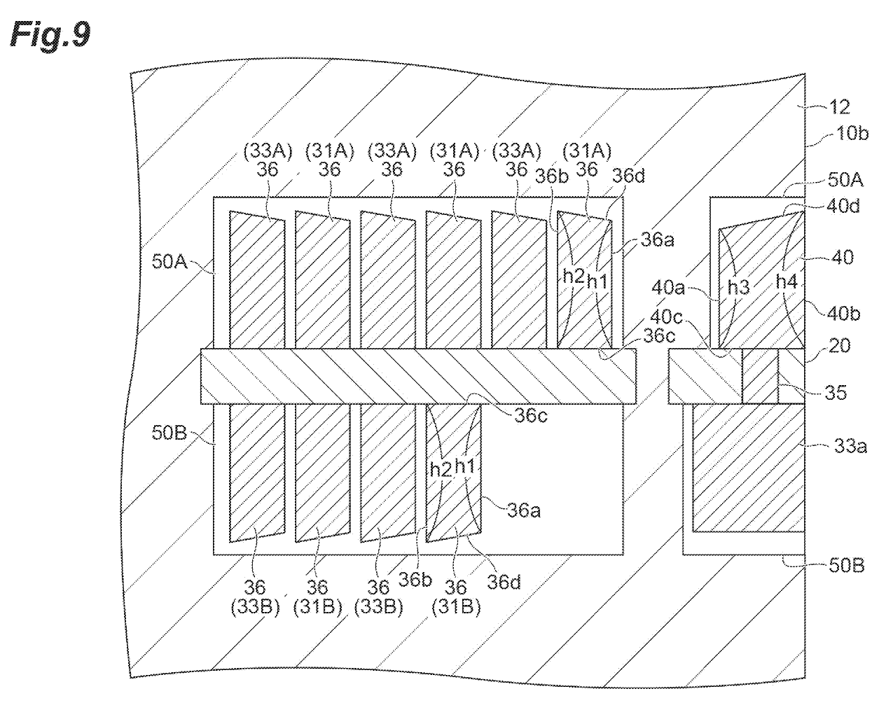

As shown in FIGS. 6 to 9, in the present embodiment, a winding 36 of each of the planar coil portions 31A, 31B, 33A, and 33B has a substantially rectangular cross-sectional shape, and specifically, has an outer side surface 36a facing a coil outer peripheral side, an inner side surface 36b facing a coil center side, a lower surface 36c in contact with the principal surfaces 20a and 20b of the insulating substrate 20, and an upper surface 36d. The upper surface 36d of the winding 36 is a surface that opposes the lower surface 36c in a thickness direction of the insulating substrate 20 on a side away from the insulating substrate 20. In the present embodiment, with respect to a length in the thickness direction of the insulating substrate 20 (i.e. a height), a length h1 of the outer side surface 36a of the winding 36 of each of the planar coil portions 31A, 31B, 33A, and 33B is shorter than a length h2 of the inner side surface 36b. A difference between the length of the outer side surface 36a and the length of the inner side surface 36b may be the same among the plurality of windings 36, or the difference between the length of the outer side surface 36a and the length of the inner side surface 36b may be different. In addition, the upper surface 36d of the winding 36 of each of the planar coil portions 31A, 31B, 33A, and 33B is inclined with respect to the principal surfaces 20a and 20b of the insulating substrate 20, that is, is inclined so as to descend (approach the insulating substrate 20) from the inner side surface 36b side toward the outer side surface 36a side. In the present embodiment, a thickness of the insulators 50A and 50B (resin bodies) covering the upper surface 36d of the winding 36 of each of the planar coil portions 31A, 31B, 33A, and 33B becomes thicker from the inner side surface 36b side toward the outer side surface 36a side. A degree of inclination of the upper surface 36d may be the same or different among the plurality of windings 36.

As shown in FIGS. 6 to 9, when one winding 36 (first winding) and another winding 36 (second winding) adjacent on an outer peripheral side of the one winding 36 exist, stray capacitance may occur between both windings 36 (in the present embodiment, a resin wall). In the present embodiment, because the length h1 of the outer side surface 36a of the winding 36 is shorter than the length h2 of the inner side surface 36b, an opposing area of both windings 36 is reduced compared to, for example, a case where the outer side surface 36a and the inner side surface 36b have the same length h2, and a reduction in stray capacitance generated between both windings 36 is achieved. In particular, when viewed from the thickness direction of the insulating substrate 20, since a total length of the outer side surface 36a of the winding 36 is longer than a total length of the inner side surface 36b, shortening the length h1 of the outer side surface 36a has a greater effect of reducing the opposing area than shortening the length h2 of the inner side surface 36b.

Furthermore, as shown in FIGS. 6 to 9, on the upper surface 20a or the lower surface 20b of the insulating substrate 20, when the outer side surface 36a of the winding 36 (outermost winding) located at an outermost periphery of the planar coil portions 31A and 31B faces an outer end portion 33a of each of the planar coil portions 31A, 31B, 33A, and 33B, stray capacitance may occur between the outermost winding 36 and the outer end portions 31a and 33a. In the present embodiment, because the length h1 of the outer side surface 36a of the winding 36 is shorter than the length h2 of the inner side surface 36b, a reduction in an opposing area between the outermost winding 36 and the outer end portions 31a and 33a is achieved compared to, for example, a case where the outer side surface 36a and the inner side surface 36b have the same length h2, and a reduction in stray capacitance generated between both windings 36 is achieved.

In the present embodiment, the metal magnetic powder-containing resin 12 constituting the element body 10 is interposed in a gap between the outermost winding 36 of the planar coil portions 31A and 31B and the outer end portion 33a on the upper surface 20a or the lower surface 20b of the insulating substrate 20 (more specifically, the metal magnetic powder-containing resin 12 and the insulators 50A and 50B are interposed), but the gap between the outermost winding 36 of the planar coil portions 31A and 31B and the outer end portion 33a may be filled with a material constituting the insulators 50A and 50B. By interposing the metal magnetic powder-containing resin 12 constituting the element body 10 in the gap between the outermost winding 36 of the planar coil portions 31A and 31B and the outer end portion 33a, leakage magnetic flux generated at the outer end portion 33a and the outermost winding 36 is reduced and mutual inductance is increased, thereby improving a coupling coefficient.

As shown in FIGS. 6 to 9, in the present embodiment, each pair conductor 40 has a substantially rectangular cross-sectional shape, and specifically, has a surface 40a (first side surface) opposing the outer side surface 36a of the winding 36 on a side away from the end faces 10a and 10b, a surface 40b (second side surface) on a side close to or exposed from the end faces 10a and 10b, a lower surface 40c in contact with the principal surfaces 20a and 20b of the insulating substrate 20, and an upper surface 40d. The upper surface 40d of the pair conductor 40 is a surface that opposes the lower surface 40c in the thickness direction of the insulating substrate 20 on a side away from the insulating substrate 20. In the present embodiment, with respect to a length in the thickness direction of the insulating substrate 20 (i.e., a height), a length h3 of the surface 40a (first side surface) opposing the outer side surface 36a of the winding 36 on the side away from the end faces 10a and 10b of the pair conductor 40 is shorter than a length h4 of the surface 40b (second side surface) on the side close to the end faces 10a and 10b.

As shown in FIGS. 6 to 9, on the upper surface 20a or the lower surface 20b of the insulating substrate 20, when the surface 40a of the pair conductor 40 and the outer side surface 36a of the outermost winding 36 of the planar coil portions 31A and 31B face each other, stray capacitance may occur between the pair conductor 40 and the outermost winding 36. In the present embodiment, in addition to the length h1 of the outer side surface 36a of the winding 36 being shorter than the length h2 of the inner side surface 36b, because the length h3 of the surface 40a of the pair conductor 40 is shorter than the length h4 of the surface 40b, a reduction in an opposing area between the pair conductor 40 and the outermost winding 36 is achieved, and a reduction in stray capacitance generated between the pair conductor 40 and the outermost winding 36 is achieved.

Note that the pair conductor 40 can be omitted, and in this case, the outermost winding 36 of each of the planar coil portions 31A and 31B faces a portion of the external terminal electrodes 60A, 60B, 60C, and 60D covering the end faces 10a and 10b instead of the pair conductor 40, and stray capacitance may occur between the outermost winding 36 and the external terminal electrodes 60A, 60B, 60C, and 60D. In the present embodiment, because the length h1 of the outer side surface 36a of the winding 36 is shorter than the length h2 of the inner side surface 36b, a reduction in an opposing area between the outermost winding 36 and the external terminal electrodes 60A, 60B, 60C, and 60D can be achieved compared to, for example, a case where the outer side surface 36a and the inner side surface 36b have the same length h2, and stray capacitance generated between the outermost winding 36 and the external terminal electrodes 60A, 60B, 60C, and 60D can be reduced. In this case, the metal magnetic powder-containing resin 12 constituting the element body 10 may be located on the outer side surface 36a side of the outermost winding 36 on the principal surfaces 20a and 20b of the insulating substrate 20, or the insulators 50A and 50B may be located.

The present disclosure is not necessarily limited to the above-described embodiments, and various modifications are possible without departing from the gist thereof. For example, the coil assembly 30 does not necessarily need to include two coils constituting a double coil structure, and may be an aspect including either one of the coils, and in this case, it can be a configuration including only one pair of external terminal electrodes.

What is claimed is:

1. A coil component, comprising:
an element body having a pair of principal surfaces facing each other, and a first end face and a second end face connecting the pair of principal surfaces;
an insulating substrate provided in the element body, extending parallel to the principal surface of the element body, and having a first main surface and a second main surface respectively facing the pair of principal surfaces of the element body;
a coil assembly provided in the element body and having a first coil that includes a first coil portion spirally wound on the first main surface of the insulating substrate, a second coil portion spirally wound on the second main surface of the insulating substrate, and a first through-hole conductor penetrating the insulating substrate to electrically connect the first coil portion and the second coil portion; and
a first external terminal provided on the first end face and electrically connected to an outer end portion of the first coil portion,
wherein with respect to a length in a thickness direction of the insulating substrate, a length of an outer side surface of an outermost winding of the second coil portion is shorter than a length of an inner side surface of the outermost winding of the second coil portion.

2. The coil component according to claim 1, wherein the outermost winding of the second coil portion has a first surface in contact with the second main surface of the insulating substrate, and a second surface opposing the first surface in the thickness direction of the insulating substrate, and
wherein the second surface of the outermost winding is inclined with respect to the second main surface.

3. The coil component according to claim 1, further comprising a resin body that fills a gap between the outermost winding of the second coil portion and the first end face on the second main surface.

4. A coil component, comprising:
an element body having a pair of principal surfaces facing each other, and a first end face and a second end face connecting the pair of principal surfaces;
an insulating substrate provided in the element body, extending parallel to the principal surface of the element body, and having a first main surface and a second main surface respectively facing the pair of principal surfaces of the element body;
a coil assembly provided in the element body and having a first coil that includes a first coil portion spirally wound on the first main surface of the insulating substrate, a second coil portion spirally wound on the second main surface of the insulating substrate, and a first through-hole conductor penetrating the insulating substrate to electrically connect the first coil portion and the second coil portion;
a first external terminal provided on the first end face and electrically connected to an outer end portion of the first coil; and
a pair conductor provided on the second main surface of the insulating substrate adjacent to the first end face and electrically connected to the first external terminal,
wherein with respect to a length in a thickness direction of the insulating substrate, a length of an outer side surface in an outermost winding of the second coil portion is shorter than a length of an inner side surface in the outermost winding of the second coil portion.

5. The coil component according to claim 4, wherein the outermost winding of the second coil portion has a first surface in contact with the second main surface of the insulating substrate, and a second surface opposing the first surface in the thickness direction of the insulating substrate, and
wherein the second surface of the outermost winding is inclined with respect to the second main surface.

6. The coil component according to claim 4, wherein the coil assembly further has a second through-hole conductor that penetrates the insulating substrate and electrically connects the outer end portion of the first coil on the first main surface and the pair conductor on the second main surface.

7. The coil component according to claim 6, wherein the second through-hole conductor is away from the first end face.

8. The coil component according to claim 4, wherein with respect to a length in a thickness direction of the insulating substrate, a length of a first side surface of the pair conductor opposing an outer side surface of an outer winding of the second coil portion on a side away from the first end face is shorter than a length of a second side surface on a side close to the first end face.

9. The coil component according to claim 4, further comprising a resin body that fills a gap between the outermost winding of the second coil portion and the pair conductor on the second main surface.

10. A coil component, comprising:
an element body having a pair of principal surfaces facing each other, and a first end face and a second end face connecting the pair of principal surfaces;
an insulating substrate provided in the element body, extending parallel to the principal surface of the element body, and having a first main surface and a second main surface respectively facing the pair of principal surfaces of the element body; and
a coil assembly provided in the element body and having a first coil that includes a first coil portion spirally wound on the first main surface of the insulating substrate, a second coil portion spirally wound on the second main surface of the insulating substrate, and a first through-hole conductor penetrating the insulating substrate to electrically connect the first coil portion and the second coil portion,
wherein at least one of the first coil portion and the second coil portion includes a first winding and a second winding adjacent to an outer peripheral side of the first winding, and
wherein with respect to a length in a thickness direction of the insulating substrate, a length of an outer side surface in the first winding is shorter than a length of an inner side surface in the first winding.

11. The coil component according to claim 10, wherein the first winding has a first surface in contact with the first main surface or the second main surface on which the first winding is provided, and a second surface opposing the first surface in the thickness direction of the insulating substrate, and
wherein the second surface of the first winding is inclined with respect to the first main surface or the second main surface on which the first winding is provided.

12. The coil component according to claim 1, wherein the coil assembly further has a second coil having a third coil portion spirally wound in parallel with the first coil portion of the first coil on the first main surface, a fourth coil portion spirally wound in parallel with the second coil portion of the first coil on the second main surface, and a third through-hole conductor penetrating the insulating substrate to electrically connect the third coil portion and the fourth coil portion.

13. The coil component according to claim 12, further comprising a magnetic body located on an outer side surface side of the outermost winding of the second coil portion on the second main surface.
